(19) United States
(12) Patent Application Publication
(10) Pub. No.: US 2023/0374310 A1
(43) Pub. Date: Nov. 23, 2023

(54) IN-SITU POLYMERIZATION OF SULFUR AND BIO-OILS IN BITUMINOUS MATRICES

(71) Applicant: Arizona Board of Regents on behalf of Arizona State University, Scottsdale, AZ (US)

(72) Inventors: Elham FINI, Phoenix, AR (US); Albert HUNG, Temple, AZ (US)

(21) Appl. No.: 18/246,803

(22) PCT Filed: Sep. 29, 2021
(86) PCT No.: PCT/US2021/052701

§ 371 Date: Mar. 27, 2023

Related U.S. Application Data
(60) Provisional application No. 63/249,431, filed on Sep. 28, 2021.
(60) Provisional application No. 63/084,703, filed on Sep. 29, 2020.

(51) Int. Cl. C08L 95/00; C10C 3/02

(52) U.S. Cl. CPC C08L 95/00; C10C 3/023; C08L 2555/34; C08L 2555/64

(57) ABSTRACT

Forming a modified bitumen includes contacting an oil with bitumen to yield a bitumen matrix comprising the oil, combining sulfur with the bitumen matrix, and reacting the sulfur with the oil to yield the modified bitumen. The modified bitumen composition includes bitumen, a sulfur component, and an oil component. The sulfur component is bonded covalently to the oil component, and the oil component is bonded covalently to the bitumen. An asphalt can include the modified bitumen.

### CROSS-REFERENCE TO RELATED APPLICATIONS

This application claims the benefit of U.S. Patent Application Nos. 63/084,703 filed on Sep. 29, 2020, and 63/249,431, filed on Sep. 28, 2021, both of which are incorporated by reference herein in their entirety.

### STATEMENT OF GOVERNMENT INTEREST

This invention was made with government support under 1928795 awarded by the National Science Foundation. The government has certain rights in the invention.

### TECHNICAL FIELD

This invention relates to in-situ polymerization of sulfur and bio-oils within a bitumen matrix, as well the resulting compositions.

### BACKGROUND

There has been emphasis in the asphalt industry to promote sustainability. Pavement sustainability can be improved by reducing mixing and compaction temperatures. Other attempts to promote sustainability have been through the use of alternative and bio-based binders. Bio-modifiers are largely the result of processing biomass that is extracted from a variety of sources, from microalgae to plant oils. Using these bio-modifiers reduces the price of the end product and the overall emission of greenhouse gases.

### SUMMARY

Forming a bio-modified bitumen includes contacting vegetable oil with bitumen to yield a bitumen matrix comprising the vegetable oil, combining sulfur with the bitumen matrix, and reacting the sulfur with the vegetable oil in the bitumen matrix to yield the bio-modified bitumen comprising an in-situ sulfur-vegetable oil polymer. The bio-modified bitumen comprises a bitumen matrix and a polymer within the bitumen matrix, and the polymer is a crosslinked vegetable oil-sulfur network. An asphalt can include the bio-modified bitumen.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 includes a method of forming modified bitumen, the method comprising contacting oil with bitumen to yield a bitumen matrix comprising the oil; combining sulfur with the bitumen matrix; and reacting the sulfur with the oil to yield the modified bitumen.

Embodiment 2 is the method of embodiment 1, wherein the sulfur comprises elemental sulfur.

Embodiment 3 is the method of embodiments 1 or 2, wherein reacting the sulfur with the oil comprises crosslinking the oil with the sulfur.

Embodiment 4 is the method of embodiment 3, wherein crosslinking the oil with sulfur comprises reacting the sulfur with an unsaturated hydrocarbon in the oil.

Embodiment 5 is the method of embodiment 4, wherein reacting the sulfur with the unsaturated hydrocarbon comprises reacting the sulfur with carbon-carbon double bonds in the unsaturated hydrocarbons.

Embodiment 6 is the method of embodiment 5, wherein reacting the sulfur with the carbon-carbon double bonds in the unsaturated hydrocarbons comprises a chain reaction of sulfur radicals with the unsaturated hydrocarbons.

Embodiment 7 is the method of embodiment 6, wherein reacting the sulfur radicals with the carbon-carbon double bonds comprises forming a first carbon-sulfur bond with a first carbon in a carbon-carbon double bond to yield a yield a first radical sulfur chain bonded to the first carbon in the carbon-carbon double bond.

Embodiment 8 is the method of embodiment 7, wherein reacting the sulfur radicals with the carbon-carbon double bonds further comprises forming a second carbon-sulfur bond with a second carbon in the carbon-carbon double bond to yield a yield a second radical sulfur chain bonded to the second carbon in the carbon-carbon double bond.

Embodiment 9 is the method of any one of embodiments 1 through 8, further comprising melt-blending the sulfur into the bitumen matrix.

Embodiment 10 is the method of embodiment 9, further comprising thermally curing modified bitumen.

Embodiment 11 is the method of embodiment 10, wherein thermally curing the modified bitumen comprises heating the modified bitumen to a temperature above about 150° C.

Embodiment 12 is the method of any one of embodiments 1 through 11, wherein the oil comprises bio-oil.

Embodiment 13 is the method of embodiment 12, wherein the bio-oil comprises vegetable oil, castor oil, oil derived from corn stover, oil derived from miscanthus, oil derived from wood pellets, or a combination thereof.

Embodiment 14 is the method of embodiment 13, wherein the vegetable oil comprises waste vegetable oil.

Embodiment 15 is the method of embodiments 13 or 14, wherein the vegetable oil comprises cis-vaccenic acid, trans-2-undecen-1-ol, 10(E),12(Z)-conjugated linoleic acid, 2-linoleoyl glycerol, or a combination thereof.

Embodiment 16 is the method of any one of embodiments 1 through 14, wherein the bio-oil comprises phenolic compounds.

Embodiment 17 is the method of embodiment 16, wherein the phenolic compounds react with sulfur radicals to form carbon-sulfur bonds.

Embodiment 18 is the method of any one of embodiments 1 through 17, wherein the sulfur comprises thiophenic sulfur.

Embodiment 19 is the method of any one of embodiments 1 through 18, wherein the modified bitumen comprises an in-situ sulfur-oil polymer in the bitumen matrix.

Embodiment 20 is the method of any one of embodiments 1 through 19, wherein the bitumen forms covalent bonds with the sulfur, the oil, or both.

Embodiment 21 is a modified bitumen formed by the method of any one of embodiments 1 through 20.

Embodiment 22 is a modified bitumen composition comprising bitumen; a sulfur component; and an oil component, wherein the sulfur component is bonded covalently to the oil component, and the oil component is bonded covalently to the bitumen.

Embodiment 23 is the modified bitumen composition of embodiment 22, wherein the bitumen is in the form of a bitumen matrix, and further comprising a polymer within the bitumen matrix, wherein the polymer comprises a crosslinked oil-sulfur network.

Embodiment 24 is the modified bitumen composition of embodiment 23, wherein the sulfur in the oil-sulfur network comprises sulfur chains.

Embodiment 25 is the modified bitumen composition of any one of embodiments 22 through 24, wherein the oil component comprises bio-oil.

Embodiment 26 is the modified bitumen composition of embodiment 25, wherein the bio-oil comprises vegetable oil, castor oil, oil derived from corn stover, oil derived from miscanthus, oil derived from wood pellets, or a combination thereof.

Embodiment 27 is the modified bitumen composition of embodiment 26, wherein the vegetable oil comprises waste vegetable oil.

Embodiment 28 is the modified bitumen composition of embodiment 27, wherein the vegetable oil comprises cis-vaccenic acid, trans-2-undecen-1-ol, 10(E),12(Z)-conjugated linoleic acid, 2-linoleoyl glycerol, or a combination thereof.

Embodiment 29 is the modified bitumen composition of any one of embodiments 25 through 27, wherein the bio-oil comprises phenolic compounds.

Embodiment 30 is the modified bitumen composition of embodiment 29, wherein the phenolic compounds are bonded covalently with the sulfur component.

Embodiment 31 is the modified bitumen composition of any one of embodiments 22 through 30, wherein the sulfur component comprises thiophenic sulfur.

Embodiment 32 is the modified bitumen composition of any one of embodiments 22 through 31, wherein the oil component and the sulfur component are in the form of an oil-linked sulfur network.

Embodiment 33 is the modified bitumen composition of any one of embodiments 22 through 32, wherein the bitumen composition comprises 1 wt % to 15 wt % or 5 wt % to 10 wt % sulfur.

Embodiment 34 is the modified bitumen composition of any one of embodiments 22 through 33, wherein the bitumen composition comprises 1 wt % to 15 wt % or 5 wt % to 10 wt % of the oil component.

Embodiment 35 is the modified bitumen composition of any one of embodiments 22 through 34, wherein the bitumen further comprises crumb rubber.

Embodiment 36 is the modified bitumen composition of embodiment 35, wherein the bitumen comprises 1 wt % to 15 wt % or 5 wt % to 10 wt % of the crumb rubber.

Embodiment 37 is an asphalt comprising the modified bitumen composition of any one of embodiments 22 through 36.

The details of one or more embodiments of the subject matter of this disclosure are set forth in the accompanying drawings and the description. Other features, aspects, and advantages of the subject matter will become apparent from the description, the drawings, and the claims.

### DETAILED DESCRIPTION

Added sulfur in bitumen exists in three forms: chemically bonded sulfur, dissolved sulfur, and crystallized sulfur. When sulfur is first melted to a liquid and then dissolved into the bitumen phase, part of the sulfur reacts and forms chemical bonds with bitumen components by the abstraction of hydrogen and by forming carbon-sulfur bonds, which act as connectors between bitumen molecules and thereby provide additional strength to the bitumen. Since bitumen can dissolve 20% or more sulfur in the temperature range of 130 to 150° C., the dissolved sulfur acts as the binder and its amount remains unchanged over time. It was observed that the excess sulfur that is not dissolved in bitumen recrystallizes as micro-particles at room temperature and be finely dispersed in bitumen as filler or micro-aggregates in colloidal suspension. The relative amount of dissolved and crystallized sulfur varies with the bitumen's origin as well as the mixing time.

Elemental sulfur actively reacts with bitumen at a temperature ranging from 220° C. to 260° C., but most of the sulfur still exists as a filler. It has been reported that the phase transitions of sulfur in bitumen are similar to those of pure crystalline sulfur, indicating that the bitumen is not plasticizing the sulfur. The effect of sulfur on bitumen varies with the bitumen's origin, the types of sulfur, the sulfur concentration, and the blending temperature. Adding sulfur to bitumen at ˜140° C. may form polysulfides and promote the ductility of bitumen, while an increased temperature (˜240° C.) may convert aromatics to asphaltenes. Adding sulfur up to 20% could induce only a 1% increase in the asphaltenes content, by reducing the solubility of aromatic and resins through dehydrogenation and cyclization. The differential scanning calorimetry analysis of sulfur-extended bitumen showed that the rhombic sulfur turns into monoclinic sulfur with a melting point at about 118° C. when the sulfur was mixed with bitumen at 145° C. Bitumen becomes softer with the addition of sulfur up to a certain dosage; beyond that, the bitumen becomes harder. Penetration increases with the introduction of sulfur, but no significant increase occurs when the sulfur dosage was increased to a dosage above 15%. The viscosity of bitumen also showed a decreasing trend up to 35% sulfur. In some cases, sulfur has a hardening effect on bitumen regardless of sulfur content, with increasing sulfur concentration leading to continuous increases in softening point, viscosity, and elastic recovery, and continuous decreases in penetration and ductility.

The effect of sulfur on bitumen properties varies with the curing time. Bitumen becomes softer after adding sulfur, but it stiffens mainly due to sulfur crystallization as curing time progresses. Sulfur crystallization can be further accelerated with an increase in temperature to 60° C.

This disclosure describes the introduction of sulfur to bio-modified bitumen containing vegetable oil (e.g., waste vegetable oil) and the synergic effect between the sulfur and the vegetable oil to yield an in-situ polymer. The reaction between sulfur and the alkenes of waste vegetable oil promotes crosslinking and the formation of C—S bonds. The sulfur chains are believed to act as crosslinkers between unsaturated hydrocarbons in the vegetable oil. The attack of sulfur radicals on alkene groups paves the way for a second attack on its neighboring carbon, leading to stable C—S bonds.

The carbon atom on each side of the existing double bonds are believed to be the reactive portions of the waste vegetable oil (WVO). The reaction starts with a radical sulfur chain interacting with one of the carbons on the side of double bonds and breaking the double bond. This first attack acts as a trigger, creating a vulnerable spot for a second attack that was found to be even more desirable, creating a stable bond. The feasible attack radii, as well as the absorption energy and the bonding energy, increase for the second attack. The S (radical sulfur chains)-C (WVO) bonds that connect the hydrocarbons create a network within bitumen that enhances its cohesion, increasing its elasticity.

The chain reactions and bond formation engage prominent species in bitumen, thereby improving the mechanical properties of bitumen. The in-situ polymer has initially high flowability, and elasticity is built gradually as curing occurs. The corresponding increase in viscoelasticity of the resulting bituminous composites can reduce asphalt permanent deformation and cracks.

Synergistic interactions between sulfur radical chains and unsaturated molecules of vegetable oil can lead to chain reactions resulting in a stable internal network in bitumen, thus yielding an effective hybrid binder. The complex modulus of bitumen can be increased by at least three times when sulfur is melt-blended into bitumen containing waste vegetable oil. This is attributed at least in part to the formation of C—S bonds as evidenced by the reduction of alkene peaks (and thus alkene bonds) in the FTIR spectra after melt-blending with sulfur and thermal curing (e.g., at 180° C.). However, the addition of sulfur without curing typically shows a negative effect on elasticity, evident as a reduction in the complex modulus of bitumen. The effect of ambient curing on regaining the lost modulus is limited. That is, samples do not fully regain modulus even after 60 days of ambient curing.

A synergistic effect between sulfur and hydrocarbon molecules is described. A two-step mechanism is identified, where first radical attacks on alkene groups by sulfur radical first breaks the double bond, and second stabilizes the resulting molecule. DFT studies show the stabilizing effect of the second step releases four times the free energy of the first radical attack. The synergistic effect of this mechanism is observed in laboratory, where the complex modulus of bitumen increased by 300% when sulfur was melt-blended into bitumen enriched by alkene bonds via addition of bio-oils. Results demonstrate the stabilization of sulfur element inside carbonaceous environments.

Bio-modifiers are largely the result of processing biomass that is extracted from a variety of sources, from microalgae to plant oils. Using these bio-modifiers reduces the price of the end product and the overall emission of greenhouse gases. The polymerization of sulfur along with a suitable bio-oil creates chains that can form networks within the bitumen matrix, thereby enhancing its mechanical properties. One example of a bio-oil is miscanthus oil—a bio-modifier for bitumen. The high phenol content of miscanthus oil can be used to form polysulfides.

In some examples, sulfur is added in its radical form to a binder comprised of bio-oil and bitumen. A mechanism for the stabilization of a (radical sulfur chains) S—C(select hydrocarbons) copolymer is described, whereby the addition of sulfur to a bio-modified bitumen yields an amorphous network of chains that contributes to the mechanical properties of the bituminous matrix. Molecular dynamics (MD) tools are paired with simulations via density functional theory (DFT) calculation to simulate the outcome of the mechanism, and the results were compared with observations via empirical methods in the laboratory.

Elemental sulfur takes many forms; the most common of its allotropes is its ring structure, which is observed as S8, S7, or S6 57. A rising temperature over 160° C. causes these rings to break open and form radical chains, which at a larger scale form a highly-reactive conglomerate. These radical chains are highly reactive, making them a suitable candidate for forming sulfur-C (hydrocarbon) copolymers through radical attacks. The stability of the bonds they form can be a limitation of the produced polymers. Given certain conditions, this S—C bonding can turn into a fusion mechanism. Four hydrocarbons show potential for creating such polymers: cis-vaccenic acid, trans-2-undecen-1-ol, 10(E),12(Z)-conjugated linoleic acid, and 2-linoleoyl glycerol. These have at least one property in common: a double bond in a long carbon chain. It is the relative vulnerability of this bond, as determined through examination of the highest Fukui value (HFV) in each molecule, which enables reactive sulfur chains to attach to the main carbon chain.

These hydrocarbons, although similar, differ slightly from each other. 10(E),12(Z)-conjugated linoleic acid has two alternate double bonds, and cis-vaccenic acid has one double bond. When attacked by radical sulfur chains, an S—C bond forms between the two species; the S—C bond breaks off the double bond and frees one of the neighboring carbon atoms to become available for a follow-up reaction. The reaction is the same: the second radical sulfur chain attaches to the most vulnerable carbon and increases the hydrocarbon's degree of saturation. However, there are subtle changes when the number and the placement of the double bonds differ; these differences affect the location of the second S—C bond. In species with a single C═C bond, the location for the second radical attack is most likely the carbon atom on the other side of the double bond, which is the case for cis-vaccenic acid. For the 10(E),12(Z)-conjugated linoleic acid that has two alternate double bonds, it becomes more complex. After the attachment of the first radical chain, the resulting radical electron does not stay on the adjacent carbon. Instead, it shifts farther and replaces the remaining double bond. This resettlement changes the location of the most vulnerable carbon to the one the radical electrons rests upon, where the second sulfur radical chain will attack. Either way, the sulfur radical attack continues until the remaining double bonds are all dissolved and S—C bonds are created in their place.

Fukui values mark the most vulnerable atoms in two prominent species (cis-vaccenic acid and 10(E),12(Z)-conjugated linoleic acid) that make up 58% of the bio-binder and two similar hydrocarbons (trans-2-undecene-1-ol and 2-linoleoyl glycerol) that have a similar number and placement of their double bonds. Fukui values show carbon atoms at each side of a simple double bond to be the most vulnerable part of the aforementioned molecules. More species in bitumen and WVO were analyzed. The mechanism was found to include the first attachment of a radical sulfur chain to a carbon atom at one side of a carbon-carbon double bond that triggers a second attachment, significantly stabilizing the overall product.

Stabilization happens as the radical electrons become restrained in a S—C bond. This process happens in two steps, with each step characterized by a radical attack. The feasible radical attack distance for the first and second attack is shown to be much higher for the first attack than that of the second. This comparison shows that the second attack is almost inevitable, given the same conditions for the first attack are met. The difference in the feasible attack distance for the first and the second attack even reaches two times the second-attack distance for some species. Among the modeled species, 10(E),12(Z)-conjugated linoleic acid proved to be the most desirable for radical attacks; however, the difference between the first and second attack radii revolves around 1.5 Å for the four chosen species.

The lengths of these S—C bonds depend on the integration of two structures; the length is near 1.90 Å for the first S—C bond. It is after the second attack and the establishment of the second S—C bond that the molecule stabilizes. The bond lengths for the second S—C bonds are shorter than that of the preliminary bonds, and after their formation, the lengths of the previously established S—C bonds are reduced from an average of 1.95 Å to 1.85 Å. The absorption energy and the bond energy better describe the tendency of the formation of a sulfur-WVO polymer. Before the first bond forms, the absorption energy determines the intensity by which the two species desire to interact and to a certain degree, the type of the bond they are likely to form. 7-tetradecene, a prominent hydrocarbon in bio-oils with desired properties, is surrounded by radical chains at its weak spot, after the formation of the first S—C bond. In the proposed mechanism, the change to the S—C pair is chosen as the main marker for each step. The first radical chain is absorbed onto the potent carbon atom at 2.55 Å. The initial S—C bond forms at 1.908 Å. The formation of this bond breaks the double bond, leaving behind a free electron on the second carbon of the newly broken bond. The existence of this electron enhances the reactivity of its respective carbon, thus allowing for a much lengthier attraction distance, here 4.65 Å. The second S—C bond shows a shorter bond length, 1.886 Å. This coincides with the shortening of the first S—C bond (to 1.875 Å, ˜2%), proving the stabilizing effect of the second attack and generally the entire process. This overall stabilization is hypothesized to be a sign of adjoining the two species via a covalent bond.

This mechanism is believed to be effective in other hydrocarbons, and thought to be the mechanism behind the strong polymerization tendencies between dicyclopentadiene and sulfur. The results show relatively shorter feasible attack distances, while the difference between the first and second attack distance remains near 1.5 Å. The bond length values and feasible radical attack distances show the WVO mixture to be a viable rival to other species suitable for using in sulfur polymerization.

Although the maximum feasible bonding distance signifies the occurrence of this mechanism, the potential and stability of such bonds are better shown through the energy indices. The absorption energy, which is the difference between the free energy values of the united species and the independent reactants, is a highly effective tool for evaluating the possibility of the formation of a sulfur-WVO polymer. Before the first bond forms, the absorption energy determines the intensity by which the two species desire to interact and to a certain degree, the type of the bond they are likely to form. The absorption tendency (represented by the free energy values) and the bonding energy values for the prominent species in WVO for both stages of polymerization were compared. In the case of the initial radical attack, all selected molecules show appropriate tendency, with the 10(E),12(Z)-conjugated linoleic acid being the most desirable for a radical attack due to its large absorption radius. The bonds formed as a result of the first radical attack show negative values, with the same order as the absorption energy. These values demonstrate the stability of the S—C bond formed. As for the second radical attack, the free energy values become much larger, nearly three or four times the energy values for the first attack. The significant rise in the absorption energy, a representative of the bonding tendency, reinforces the hypothesis that the first attack acts as a trigger for the second. The bond energy follows the same trend, rising to three or four times the bond energy values for the initial S—C pair. Observing the absorption energy for the secondary S—C bonds reveals that they are most likely to form, and the resulting bonds are more stable than the bonds formed after the first radical attack.

These calculations suggest that an overwhelming number of sulfur chains, if permitted enough time and motility, can stabilize certain carbonaceous species. These species are mostly the ones with double bonds, with an oxygen atom in the vicinity (but not the immediate vicinity) of the potential radical-attack targets. Also, the chain that connects said carbon to the main structure is thought to have alternating double bonds, to provide an even stronger vulcanization. The following radical attack, provided said conditions are met, can strengthen prior S—C bonds. The free energy values and the bond energy values for the prominent candidates for sulfur-hydrocarbon polymerization was calculated. An increase in temperature corresponds to an increase in the tendency of the sulfur radicals and hydrocarbons to interact. This is expected, not only because of the obtained values, but because of the reduced viscosity (which enhances mixing) and increased radicalization of the existing sulfur. This is a recurring theme in the examined materials. There are, however, hydrocarbons for which this effect is minimal. Given a similar increase in temperature, the absorption tendency of 4-allyl-2,6-dimethoxyphenol rises from near 0 to a more acceptable value of −3 kcal/mol. The rise in the absorption energy of the other molecules, although as high as 100%, changes little in terms of reactivity, as these molecules are already highly reactive in the presence of radical sulfur chains. The bond energy for the newly-formed S—C bond is around 30 kcal/mol, which is higher than most of the S—C bonds that were studied. As for the second radical attack, some hydrocarbons show similar susceptibility as compared with the hydrocarbons in WVO. This is also the same for the S—C bonds after the second attack, where both bonding energies are about 65 kcal/mol except for 2-methoxy-4-vinylphenol, for which the bond energy for the second bond is 40% lower than that of the first bond. In the rest of the cases, this difference is about 10-15%.

The charge density of the species, both before and after the attacks, were calculated. A sigma profile concentrated at the middle (at zero on the x-axis) means a molecule has little polarity. Except for 7 tetradecene and dicyclopentadiene, which are both nonpolar, the other molecules show little polarity. This starts to change by the attachment of sulfur chains, as the molecular charge starts to be more evenly distributed. This change is most visible after the second radical attack, as even the influence of the ketone and phenolic functional groups becomes pale in comparison to the sulfur chains. This significant change to the polarity of the molecule attests to its overall stabilization as a result of the two-step mechanism.

Dicyclopentadiene (DCPD) is a strong polymerization agent for the radical sulfur chains in high temperatures. The first component, sulfur, a yellow solid at 25° C., becomes a fluid at nearly 120° C. as its octagonals break into radical chains. The second component, DCPD, is a ringed hydrocarbon with two double bonds. The result of their mixture at 160° C. is a polymer that forms in between previously isolated sulfur grains. These connected chains form an interconnected material. In each phase, the most reactive spots of the stabilizer (DCPD) are attacked by radical sulfur chains to create a stable copolymer. The glass transition temperature (Tg), better describes this progress. As the ratio of the DCPD to sulfur increases from 7.5 to 22.5%, the copolymerization transforms higher shares of sulfur into the amorphous polymer. Tg values show this transition with the disappearance of the crystal phase from the mixture; higher shares of DCPD help create an amorphous setting with little to no sudden change in its behavior against rising temperature. The XRD results confirm that DCPD has initiated copolymerization with sulfur, resulting in an amorphous polymeric form. The mechanical tests show that in case of DCPD, the optimal ratio is 95% sulfur-5% DCPD, passing which the coherence of the specimen starts to break down.

As a crosslinker, the effective addition of sulfur greatly affects the structure of the bitumen. The sulfur radical attacks break alkene groups and form bonds between various detached hydrocarbons to create networks inside the mixture, which would change its overall mechanical performance. To achieve this, a particular curing procedure was designed. The structural changes to the S-WVO bio-binder are evident. FTIR observations show the thermal curing to be effective in promoting the formation of S—C bonds and the creation of a network inside the bitumen matrix. This was evidenced in a reduction in alkenes during the thermal curing. The peaks marking the C— C double bond (1620-1680 cm⁻¹) are relaxed in the specimen with thermal curing, as well as the vinyl-related compounds (990-900 cm⁻¹). This is coincided with the reduction in the oxygen content (1260-1050 cm⁻¹) in the mix, which can be attributed to the successful release and burning of oxygen in the process. These observations demonstrate the effectiveness of the thermal curing method in creating an amorphous matrix, where various species are linked via sulfur chains in an inhomogeneous network, which is in agreement with the flattening of the sulfide interval (600-500 cm⁻¹), possibly due to prevention of re-crystallization and instead, consolidation of sulfur chains in a C—S network.

In the rheological analysis, it was initially observed that the addition of sulfur to control bitumen significantly reduced the complex shear modulus of the control bitumen. The sample slowly started to regain its lost modulus as curing time progressed; however, it did not fully regain the lost modulus even after 60 days of curing. Mixing and reheating the sample at 150° C. for 30 min was not effective to fully regain the lost modulus, either. To facilitate the formation of sulfur free radicals, a specimen was melt-blended at 180° C. for 30 min. The chain reactions of sulfur free radicals and bitumen containing waste vegetable oil not only helped the bitumen regain its lost modulus; they also led to an increase in the complex modulus. The complex modulus increased to become three times higher than that of the control bitumen. This substantial increase was attributed to the chain reactions of sulfur radicals and unsaturated hydrocarbons in waste vegetable oil. Without the stabilization sulfur recrystallizes over time. However, here, the stabilization helps give rise to formation of permanent sulfur-carbon bonds.

The formation of such bonds creates cohesive S—C species; depending on the level of sulfur integration, these cohesive S—C species are connected by vdW bonds. While the sulfur chains are covalently connected to the carbonaceous species to form the polymer, amalgamate of the produced polymer is held together with the relatively weak vdW interactions. These distinct connections (covalent S—C bonds and vdW interactions) create a chasm between the possible modes of failure at two different levels.

Failure in the covalent S—C bond can be shown against strain. With increasing displacement, the inherent twist in the polymer is straightened and the failure happens in the form of a snap in one of the S S bonds, as they usually have lower bonding energy compared with their counterparts in the polymer. In some cases, a certain bond has to be severed for the chain to fail, and the failure happens as the attraction gradually fades with increasing distance.

For the first mode of failure, three different species are compared by their stress-strain characteristics. In the first mode, where the failure happens at the break of a covalent, all three species show similar behavior; failure happens at 2.5 GPa and about 0.6 strain. For the second mode, although all three mentioned species have the same failure process, the maximum tolerated tensile stress and strain values vary. The 7-tetradecene shows the highest tolerated tensile stress: 0.21 GPa, corresponding with 0.12 strain. Ethyl vinyl ketone and 2-methoxy-4-vinylphenol show a lower peak for the tensile strength at 0.17 GPa and ˜0.7 strain. In addition, the high area under the stress-strain diagram of the 7-tetradecene demonstrates its tolerance for external stress and the subsequent deformations. The combined mechanisms of failure on two levels provide a high degree of stress and deformation tolerance, at the first stage mainly for preserving the main components, and at the second stage for delaying the overall rupture.

The cohesion in the bitumen matrix is evaluated using a pull-out test, where the upper layer of the copolymer is slowly forced to slide over the lower layer (bitumen). The resistance recorded as the pull-out stress determines the bonding energy between the two sliding matrices and therefore the existing cohesion between them. In full interaction mode, where both layers have maximum overlap, resistance to sliding is at its peak. With increasing displacement, the interaction between the layers is reduced; progressively more atoms from both sides pass the effective distance for interaction. The applied stress versus the displacement shows much higher shear resistance between sulfur polymer and bitumen versus the bitumen-bitumen interface. The difference increases as a share of the bitumen-bitumen shear strength with displacement, highlighting the possible effectiveness of sulfur polymer in binding the bitumen matrix together. The high cohesion means that the sulfur polymer-bitumen interface shows higher pull-out strength in a 25-30 Å interval than is shown by the bitumen-bitumen interface in 20-25 Å, once again stressing the beneficial role of WVO-S as a reinforcing additive for bitumen. To test the strength of the sole WVO-S polymer, the MD model was put under tensile stress. The results are provided in two mediums: in the interatomic chemical bonding phase (FIG. 7h) and in the intermolecular van der Waals phase. Stress-strain results at the interatomic scale attest to the superiority of the S—C bond that connects the radical sulfur chains to the 10(E),12(Z)-conjugated linoleic acid molecule, which shows higher ultimate stress corresponding with higher strain toleration. The 10(E),12(Z)-conjugated linoleic acid had shown itself to be the most attractive candidate due at least in part to its high absorption and the significant bond stability it provides when attached to a sulfur chain. At the intermolecular level, the addition of sulfur polymer enhances the overall mechanical performance of the matrix by increasing the ultimate tolerated stress by more than 30%. This is a result of the stiff sulfur polymer that has nearly double the elastic modulus of the bitumen. The results show that sulfur-waste vegetable oil with long chains can form extensive entanglement between the species that form bitumen. This transformation unifies the previously vdW-attached species with said chains and spreads the applied stress more evenly throughout the bituminous matrix.

### EXAMPLES

### Example 1

### Materials and Methods

The asphalt used in this example is PG 64-22 (Table 1). The waste vegetable oil (WVO) was obtained from Mahoney Environmental Inc., Phoenix, AZ, a processing facility for waste cooking oil. Sulfur with reagent grade was provided by Fisher Science Education. To prepare the specimens, 10% sulfur was added to bitumen containing waste vegetable oil by the weight of bitumen and blended using a high-shear mixer at 3000 rpm. The sulfur-doped samples were cured at ambient temperature for 60 days before testing. In a second scenario, samples were melt-blended at 180° C. for 30 min, referred to as thermal curing.

### Attenuated Total Reflectance Fourier-Transform Infrared Spectroscopy (ATR-FTIR)

A Bruker IFS 66V/S Vacuum FT-IR spectrometer with diamond ATR and pyroelectric DLaTGS detector was used to characterize the functional groups of each specimen. An FT-IR spectrum range with wavenumbers from 400 to 4000 cm⁻¹ was collected with a resolution of 4 cm⁻¹ with 32 scans per second. OMNIC software was used to calculate the areas under the peaks in each spectrum.

### Gas Chromatography-Mass Spectroscopy

Waste vegetable oil was analyzed using a gas chromatography-mass spectrometer (GC-MS) for chemical and molecular composition. Each sample was dissolved in dichloromethane and filtered through a 0.2 μm PTFE filter prior to injection into the GC column. A DB-5 column (30 m×250 μm×0.25 μm) was used to separate molecules based on molecular weight. The carrier gas (helium) was maintained at 1 ml/min throughout the analysis. The samples were diluted 10-fold before 1 μl was injected into the column in split-less mode. The inlet temperature was maintained at 280° C., the transfer line temperature was 250° C., and the source temperature was 230° C. The chromatogram and the major peaks were processed and integrated using ChemStation and matched to the NIST17 database.

### Rheometry

Rheological analysis was performed using a dynamic shear rheometer (Anton Paar MCR 302). An oscillation test was performed at 52° C. and angular frequencies ranging from 0.1-100 rad/s using a parallel-plate setup. The sample was made into a disk 8 mm in diameter and 2 mm thick and placed in the parallel-plate setup to perform the test. The complex modulus (G*) was calculated from Equation 1 using shear strain and shear stress data collected during the test.

$${G}^{*} = \frac{{τ}_{max}}{{γ}_{max}} \qquad ( 1 )$$

in which

$$γ = {( \frac{θ r}{h} )}_{max} and τ = \frac{2 τ}{π {r}_{max}^{2}}$$

where:
γₘₐₓ=maximum strain
τₘₐₓ=maximum stress
T=maximum applied torque
r=radius of sample
θ=deflection (rotational) sample
h=height of the sample

### DFT Calculations and MD Simulations

Quantum-mechanical calculations in a dispersion-corrected density functional theory (DFT-D) framework were used to provide an atomistic description of the molecular system's performance. All optimizations were performed through the DMol3 module of the Accelrys Materials Studio program package (version 6.0). The generalized gradient approximation (GGA) and Perdew-Burke-Ernzerhof (PBE) functional were used to treat exchange-correlation interactions. PBE is the most universal GGA that could be applied to both molecules and solids. Errors of nonempirical functionals, such as PBE, usually have a “systematic” tendency. The systematic errors of PBE make it easier to estimate the target property. Moreover, these functionals provide a high accuracy for relative quantities such as bond length changes, frequency shifts, and energy differences.

In the MD simulation, a random algorithm was used to produce a sulfur composite modified by WVO. 80% sulfur chains and 20% WVO was used for the composite, attached where the tendencies are maximum, i.e., where the carbon-sulfur bond is stable. The model was intended to preserve the periodic boundary conditions in three dimensions, thus presenting a suitable model for the sulfur composite under thermodynamic interactions with various molecules in the bitumen model. The dimensions for the periodic cell of CSH were set to 30 Å×A×30 Å. The COMPASS force field was used to model the interatomic interactions between a sulfur polymer and the bitumen matrix. The designed system reaches an equilibrium at its lowest energy level. Optimizing the structure of the nanocomposites and minimizing the energy level were achieved using the SMART method, which is a combination of the steepest descent, conjugate gradient, and Newton-Raphson methods. In order for the system to reach P=0.0001 GPa (air pressure) and T=400 K, a total analysis time of up to 500 ps with NPT ensemble was used to optimize the shape of the supercell and allow for the interactions to happen in 400 K. This was followed by 500 ps stabilization in 298 K; this process was designed to resemble the mixing and reacting process at high temperatures and stabilization at room temperature. Results were extracted under an NVT ensemble for 500 ps in 298 K to ensure constancy. A Nose thermostat and Berendsen barostat were set to control the temperature and pressure, respectively.

### Results

It was observed that the addition of sulfur to control bitumen significantly reduced the complex shear modulus of the control bitumen. The sample slowly started to regain its lost modulus as curing time progressed; however, it did not fully regain the lost modulus even after days of curing. Mixing and reheating the sample at 150° C. for 30 min was not effective to fully regain the lost modulus, either. To facilitate formation of sulfur free radicals, a specimen was melt-blended at 180° C. for 30 min. The chain reactions of sulfur free radicals and bitumen containing waste vegetable oil not only helped the bitumen regain its lost modulus, they also led to a surge in the complex modulus. The complex modulus increased to become three times higher than that of the control bitumen. This substantial increase was attributed to the chain reactions of sulfur radicals and unsaturated hydrocarbons in waste vegetable oil.

The latter observation is attributed to thermal curing promoting the formation of C—S bonds and the creation of a network inside the bitumen matrix. This was evidenced in a reduction in alkenes during the thermal curing.

Elemental sulfur takes many forms; the most common of its allotropes is its ring structure, which is observed as S₈, S₇, S₆, etc. A rising temperature over 160° C. causes these rings to break open and form radical chains, which in a larger scale form a highly-reactive conglomerate. To assess the possibility of a S—C fusion mechanism, molecular models were used for the prominent species in waste vegetable oil (referred to as “bio-binder”) (Table 1).

TABLE 1
Prevalent Molecular Species in Bio-binder

| Name | Formula (DB) | % Concentration |
|---|---|---|
| cis-vaccenic acid | C18H34O2 | 44% |
| 10(E),12(Z)-conjugated linoleic acid | C18H32O2 | 14% |
| octadecanoic acid | C18H36O2 | 12% |
| n-hexadecanoic acid | C16H32O2 | 5% |
| 9-octadecenoic acid (Z)-, 2,3- | C21H40O4 | 5% |
| dihydroxypropyl ester | | |
| Total | | 80% |

Except for the n-hexadecanoic acid, which is a saturated hydrocarbon, other species show strong affinity with sulfur radicals. This is shown in FIGS. 3B and 3C with Fukui values marking the most vulnerable atoms in two prominent species (cis-vaccenic acid and 10(E),12(Z)-conjugated linoleic acid) that make up 58% of the bio-binder and two similar hydrocarbons (trans-2-undecene-1-ol and 2-linoleoyl glycerol) that have a similar number and placement of their double bonds. As can be seen, Fukui values show carbon atoms at each side of a simple double bond to be the most vulnerable part of the aforementioned molecules. When attacked by radical sulfur chains, an S—C bond forms between the two species; the S—C bond breaks off the double bond and frees one of the neighboring carbon atoms to become available for a follow-up reaction. Here, the second radical sulfur chain attaches to the hydrocarbon, increasing their degree of saturation. This process is shown in steps for cis-vaccenic acid and 10(E),12(Z)-conjugated linoleic acid. There are subtle changes when the number and the placement of the double bonds differ. These changes concern the location of the second S—C bond. In species with a single C═C bond, the location for the second radical attack is most likely the carbon atom on the other side of the double bond, which is the case for cis-Vaccenic acid. For the 10(E),12(Z)-conjugated linoleic acid that has two neighboring double bonds, however, it becomes more complex. After the attachment of the radical chain, the radical electron shifts farther than the saturated carbon, creating a new double bond and settling on the carbon at the end of the newly broken double bond, thereby making it the most vulnerable for the second attack. This reaction continues until the remaining double bond is dissolved and two other S—C bonds are created instead.

The first attachment of a radical sulfur chain to a carbon atom at one side of a carbon-carbon double bond triggers a second attachment that stabilizes the overall product.

This can be shown in terms of bonding energies for both S—C bonds, especially in the case of the first bond before and after the formation of the second S—C bond. The status of the S—C bonds in each stage was investigated. The desirability of the first attack and the second attack can be determined by the distance between the sulfur and carbon atoms that make the bonding possible. The feasible distance for the second bond is much higher, confirming the trigger role of the first attack. Among the modeled species, 10(E),12(Z)-conjugated linoleic acid has been shown to be the desirable for radical attacks; here, the difference between the first and second attack radii revolves around 1.5 Å.

After the first attack is initiated, an S—C bond forms as a result of a covalent bond forming between the two species. The lengths of these bonds depends on the integration of the two structures, which is more or less near 1.90 Å for the first S—C bond. It is after the second attack and the establishment of the second S—C bond that the molecule stabilizes. It shows that not only are the bond lengths for the second S—C bonds shorter than the preliminary bonds, but after their formation, the lengths of the previously established S—C bonds are reduced (from an average of 1.95 Å to 1.85 Å). The absorption energy and the bond energy better describe the tendency of the formation of a sulfur-WVO polymer. Before the first bond forms, the absorption energy determines the intensity by which the two species desire to interact and to a certain degree, the type of the bond they are likely to form. Values show the 10(E),12(Z)-conjugated linoleic acid to be desirable for a radical attack, which corresponds to its large absorption radius. Other species also show a tendency toward the radical sulfur chains. The same trend is also observed for the bonding energy; it demonstrates that the affinity between the hydrocarbons and radical sulfur chains grows as the distance decreases. Observing the absorption energy for the secondary S—C bonds reveals that they are significantly more possible to form. Data show nearly 2 to 5 times the absorption energy for the first bond, and suggests that the resulting bonds are also more stable than the primary bonds formed after the first radical attack. Overall, the absorption and bonding energies for all of the models was sufficient to form a stable bond, given they become close enough to initiate the radical attack.

To better assess the effects of these bonds at a larger scale, an MD model was used with some of the most prevalent hydrocarbons in bitumen: asphaltene, aromatics, and resins. Using a mix of these models, a bitumen cell was created. Using this cell as a presentation of the bituminous matrix, the interactions between hydrocarbons and the sulfur-WVO polymer that are responsible for the enhanced mechanical properties can be studied at a molecular scale, using bonding energy as the major index.

The cohesion in the bitumen matrix is evaluated using a pull out test, where the upper layer (S—C polymer) is slowly forced to slide over the lower layer (bitumen). The resistance recorded as the pull out stress determines the bonding energy between the two sliding matrices and therefore, the existing cohesion between them. In full interaction mode, where both layers have maximum overlap, resistance to sliding is at its peak. With increasing displacement, the interaction between the layers contracts; more and more atoms from both sides pass the effective distance for interaction. The applied stress versus the displacement shows higher shear resistance between sulfur polymer and bitumen versus the bitumen-bitumen interface. The difference increases as a share of the bitumen-bitumen shear strength with displacement, highlighting the possible effectiveness of sulfur polymer in binding the bitumen matrix together. The high cohesion means that the sulfur polymer-bitumen interface shows higher pull out strength in a 25-30 Å interval than is shown by the bitumen-bitumen interface in 20-25 Å, once again stressing the beneficial role of WVO-S as a reinforcing additive for bitumen. To test the strength of the sole WVO-S polymer, the MD model was put under tensile stress. The results are provided in two mediums: in the interatomic chemical bonding phase and in the intermolecular Van der Walls phase. Stress-strain results at the interatomic scale attest to the superiority of the S—C bond that connects the radical sulfur chains to the 10(E),12(Z)-conjugated linoleic acid molecule, which shows higher ultimate stress corresponding with higher strain toleration. This is in agreement with the results, in which the 10(E),12(Z)-conjugated linoleic acid had shown itself to be an attractive candidate due to its high absorption and the significant bond stability it provides when attached to a sulfur chain. At the intermolecular level, the addition of sulfur polymer enhances the overall mechanical performance of the matrix by increasing the ultimate tolerated stress by more than 30%. This is a result of the stiff sulfur polymer that has nearly double the elastic modulus of the bitumen. Results show that sulfur-waste vegetable oil with long chains can form extensive entanglement between the species that form bitumen. This transformation unifies the previously vdW-attached spaces with said chains and spreads the applied stress more evenly throughout the bituminous matrix.

### Example 2

Sulfur was combined with rubberized bitumens containing various types of bio-derived molecules, representing bitumens of different known compositions. The effects of sulfur on the thermo-mechanical properties of the bio-modified rubberized bitumens were examined, and those effects were related to the specific compositions of the bio-modifiers. The effect of sulfur on bio-modified rubberized bitumen was shown to depend on the bio-modifier's chemical composition. Rubberized bitumen was modified with bio-derived compounds from castor oil (CO), corn stover (CS), miscanthus (MS), wood pellets (WP), and waste vegetable oil (WVO). The effect of sulfur on the evolution of the thermo-mechanical and chemical properties of rubberized bitumen was monitored for 60 days. The introduction of sulfur was shown to reduce the elasticity of rubberized bitumen. As curing time progressed, the elasticity was regained to some extent. Each case had a different curing rate, with WVO having the overall fastest curing rate and WP having the slowest. The observed curing phenomenon was attributed to the progress of sulfur recrystallization and sulfur-bitumen interactions. Among all scenarios, bio-modified rubberized bitumen containing vegetable oils (CO and WVO) was more impacted by the introduction of sulfur, as evidenced by the highest change in elasticity, the greatest percent recovery, and the fastest curing rate. In addition, vegetable-oil-based scenarios showed a continued gain in elasticity even after 60 days. The latter was attributed to vegetable oils having the highest content of unsaturated compounds, giving rise to sulfur-bitumen reactions. Infrared spectroscopy results showed continuous increase of carbon-sulfur bond indexes and decrease of alkene during the curing time. The latter was most evident in the cases of CO and WVO, with alkene reductions of 10.7% and 10.8%, respectively, during the 60-day curing.

### Materials

The reference (control) sample was bio-modified rubberized (BMR) bitumen. This includes five different BMR made from Castor oil (CO-BMR), Corn Stover (CS-BMR), Miscanthus (MS-BMR), Wood Pellet (WP-BMR), and Waste Vegetable Oil (WVO-BMR); the basic properties of bio-modifiers are given in Table 2. The preparation of BMRs was done by a method known in the art. To prepare BMRs, crumb rubber (15% wt.) and bio-modifiers (15% wt.) were added into PG 64-22 (70% wt.) (Table 3) and mixed at 180±5° C. for 30 min with a shearing speed of 3000 rpm. The crumb rubber had a particle size smaller than 0.42 mm and was made from waste tire rubber. Bio-modifiers were obtained from biomass. The specific intervention involves doping each of the abovementioned BMRs with 10% sulfur by weight of the corresponding BMR. Sulfur was obtained from Fisher Science Education with a reagent grade. Mixing of sulfur and BMRs was done at a temperature of 155±5° C. for 30 minutes using a mixer at 1000 rpm.

TABLE 2
Basic properties of bio-modifiers.

| Properties | CO | CS | MS | WP | WVO |
|---|---|---|---|---|---|
| Density (g/cm³) | 0.881 | 1.250 | 1.050 | 1.230 | 0.898 |
| C (%) | 77.80 | 61.6 | 65.77 | 61.05 | 77.30 |
| H (%) | 12.66 | 7.28 | 7.31 | 6.93 | 12.08 |
| O (%) | 9.46 | 30.16 | 26.25 | 31.81 | 10.50 |
| N (%) | 0.08 | 0.96 | 0.67 | 0.21 | 0.12 |
| Saturates (%) | 20.95 | 6.8 | 6.22 | 3.46 | 0.00 |
| Aromatics (%) | 0.00 | 3.73 | 8.56 | 2.93 | 87.19 |
| Resins (%) | 78.17 | 67.49 | 60.47 | 76.21 | 12.80 |
| Asphaltenes (%) | 0.87 | 21.96 | 24.47 | 17.38 | 0.00 |

TABLE 3
General properties of PG 64-22.

| Properties | Values |
|---|---|
| Specific gravity @15.6° C. | 1.041 |
| Cleveland open cup method flash | 335° C. |
| point | |
| Mass change after RTFO | −1.3% |
| Absolute viscosity @ 60° C. | 179 Pa · s |
| Stiffness @−12° C., 60 s | 85.8 MPa |

### Methods

To study the effect of curing time on the BMR's properties, the prepared BMR specimens containing sulfur were placed at room temperature for five curing time: 0, 7, 14, 30, and 60 days.

### Tests of Rheological Properties

An Anton Paar MCR 302 dynamic shear rheometer was used to test the rheological properties of the BMRs with and without sulfur dopant. The frequency sweep at 52° C. with angular frequencies ranging from 0.1 rad/s to 100 rad/s using a parallel plate (8-mm diameter) with 2-mm gap was used to measure the complex modulus (G*) and phase angle (δ) of the BMRs. The multiple stress creep and recovery test (MSCR) was conducted at 52° C. using 25-mm plate to obtain the percent recovery (R) and non-recoverable creep compliance (Jₙᵣ) of the BMRs. Ten cycles of 1-second creep and 9-seconds recovery were applied to the samples under two stress levels (0.1 kPa and 3.2 kPa). The frequency sweep and MSCR testing procedures followed the standard test methods of ASTM D7175 and AASHTO T350, respectively.

### Attenuated Total Reflectance-Fourier Transform Infrared Spectroscopy (ATR-FTIR)

A Bruker IFS 66V/S Vacuum FTIR with diamond ATR was used to detect changes in the functional groups of BMRs with/without sulfur. The diamond crystal surface was cleaned with acetone before testing, and the background spectrum was collected first and subtracted from the spectra of the tested sample. The wavenumber ranged from 4800 to 400 cm⁻¹ with a scan frequency of 32 times/min at a resolution of 4 cm⁻¹ in a vacuum environment at room temperature.

### Results

### Complex Modulus and Phase Angles

The dynamic frequency sweep test for all BMRs without and with sulfur was conducted at 52° C. It was found that the addition of sulfur (W/S-0d) reduced the G* of all BMRs significantly comparing to the control BMRs (W/O S). As G* is a key indicator used to represent the stiffness of bitumen at intermediate temperatures, the decreased G* indicated that sulfur incorporation softened the BMRs; this softening is attributed to that sulfur may act as a weak-phase in bitumen matrix due to the plasticizing effect of sulfur on the bitumen. Such sulfur-induced plasticity should be responsible for the reduced G*. The sulfur in bitumen exists in three forms: dissolved sulfur, chemically bonded sulfur, and crystalline sulfur. The proportion of chemically bonded sulfur highly depends on bitumen compositions with phenolic compounds showing a high affinity for the reaction; however, overall the sulfur-reacted compounds are low because of the reaction time and temperature during the blending is relatively. The sulfur does not crystallize immediately upon cooling, so the proportion of crystallized sulfur is low as well. Accordingly, most of the sulfur phase remains in the amorphous and dissolved form, this in turn softens the bitumen. As time elapses, the sulfur continues to react with the bitumen components giving rise to internal network of organic molecules while excess sulfur crystallizes into micrometer-sized structures. The latter can lead to the so-called curing phenomenon, which increases bitumen stiffness. The G* of BMRs increased gradually as the curing time increased from 0 days to 60 days, and the G* of rubberized bitumens cured for 60 days containing the bio-modifiers CO, CS, and MS were close to or even above the original G* of the BMRs. CO-BMR and WVO-BMR had the highest G* increase during the first 7 days of curing; after that, the increase became slower. To ensure that the observed property change is due to sulfur dopant, the reference materials (BMRs) were exposed to the same exact curing condition and no changes were observed. The latter was examined by comparing each BMRs complex modulus before and after curing condition. The results showed that there were no changes in the properties of BMRs conditioned to the same exact curing protocol as sulfur-doped BMRs. This in turn confirms that the observed property changes in sulfur-doped BMRs are due to the curing phenomenon. The recrystallization of the dissolved and dispersed sulfur in the bitumen matrix and the continuous sulfur-BMR interaction during the curing time can explain the G* increase during the curing. The introduced sulfur can partially congeal into crystalline sulfur particles and give additional strength to the bitumen. The sulfur continues to react with the bitumen compounds and form sulfur-containing networks in the bitumen phase, thus enhancing the elasticity of the bitumen. As a result, the G* of the BMRs increased with increased curing time.

The phase angles (δ) of BMRs were measured without and with sulfur. The δ of WVO-BMR increased by roughly 8 degrees after adding sulfur, followed by CO-BMR (˜10 degrees), MS-BMR (16 degrees), and CS-BMR (˜18 degrees); WP-BMR showed the highest increase by roughly 22 degrees. The increase in δ indicates increased viscous response for BMRs, resulting in rutting risk at high temperature but desirable cracking resistance at low temperature. During the curing process, the δ of all BMRs continued to decrease. CO-BMR had a significant decrease in δ during the first 7 days and caught up to the δ of the bitumen without sulfur after 60 days of curing. This phenomenon was also found in WVO-BMR. However, the 6 of CS-BMR, MS-BMR, and WP-BMR basically remained unchanged after 7 days of curing, and there were still great gaps in δ between the samples cured for 60 days and the original samples. Overall, the viscoelastic indicators of G* and δ show the softening of BMRs due to the incorporation of sulfur and hardening of BMRs after curing.

### Rutting Resistance Indicator (G*/Sin δ)

The Superpave rutting parameter G*/sin δ, known as the rutting factor, was calculated to evaluate the effect of sulfur on the high-temperature performance of BMRs. The original BMRs were softened by the dissolved and dispersed sulfur, as shown by the decrease in G*/sin δ of W/S-0d. However, G*/sin δ grew gradually during the curing, showing improved rutting resistance. After 60 days of curing, the G*/sin δ values of all BMRs containing sulfur, except WP-BMR, were approximately equal to the G*/sin δ values of the original BMRs without sulfur; this can be attributed to the aforementioned sulfur recrystallization and reaction with bitumen compounds.

To further investigate the evolution of the properties of rubberized bitumen containing different types of bio-modifiers, the Curing Index (CI) of each of the five types of BMRs with sulfur was calculated according to Equation 1, based on the change in their properties during each curing period. CI is used as an indirect measure of sulfur-bitumen reaction. The fact that each bio-modified bitumen showed a unique CI value even though they were all exposed to the same conditioning protocol, shows curing is highly affected by bitumen's composition. This, in turn, highlights the source dependency of the effect of sulfur on bio-modified rubberized bitumen.

$$CI = \vert \frac{cured value - uncured value}{uncured value} \vert \times 100 \%$$

For CO-BMR and WVO-BMR, the CI increased rapidly in the first 14 days. For CS-BMR and WP-BMR, the CI did not change much in the first 7 days, then it increased rapidly in the section to 14 days. The CI of MS-BMR also did not show much increase in the first 7 days, then grew at a higher rate from 7 to 30 days. One similarity is that the growth of all BMRs slowed at 30 days. After 60 days of curing, CO-BMR showed the highest change in rutting factor with the highest CI, followed by WP-BMR, CS-BMR, MS-BMR, and WVO-BMR.

Fatigue performance indicator (G*Sin δ)

The Superpave fatigue factor G*sin δ was also used to evaluate the fatigue performance of the BMRs without and with sulfur. With the addition of sulfur to the BMRs, their G*sin δ values have great reductions and show enhanced fatigue resistance of the bitumen. All BMRs with sulfur showed a similar trend during the curing period: a noticeable increase in G*sin δ values, indicating decreased fatigue resistance. Among the five types of BMRs, the G*sin δ values of CS-BMR and MS-BMR after 60 days of curing exceed those of their corresponding original BMRs without sulfur. G*sin δ-based CI was assessed in different curing periods. The evolution of G*sin δ-based CI had the same trend as for G*/sin δ-based CI; after 60 days, CO-BMR shows the highest CI (and was highest during the curing), followed by WP-BMR, CS-BMR, MS-BMR, and WVO-BMR.

### Multiple Stress Creep and Recovery Test (MSCR)

Creep and recovery tests were conducted to evaluate the effects of sulfur on the elastic response and resistance to permanent deformation of the BMRs at high temperature. The percent recovery (R) and non-recoverable creep compliance (Jₙᵣ) at the two stress levels of 0.1 kPa and 3.2 kPa were assessed. The addition of sulfur had a great impact on the creep and recovery response of BMRs. The WP-BMR had a surge in Jₙᵣ by 1680.0% (average increase percent at 0.1 kPa and 3.2 kPa, the same below), followed by CS-BMR (1105.1%), MS-BMR (931.0%), and CO-BMR (442.6%), while WVO-BMR had a relatively small increase of 398.9%. The R suffered a significant decrease with the addition of sulfur. Decreases of 46.3%, 53.0%, 42.4%, 16.8%, and 77.6% were observed at 0.1 kPa for R of CO-BMR, CS-BMR, MS-BMR, WP-BMR, and WVO-BMR, respectively. At 3.2 kPa, the R of CO-BMR and WVO-BMR decreased to zero, and those samples lost their elasticity. However, as demonstrated in the section on complex modulus and phase angles, sulfur-containing BMRs could recover part of their elastic properties during the curing, due to sulfur recrystallization and sulfur-BMR chemical reactions. Thus, a continuous decrease in Jₙᵣ and increase in R were observed for the cured BMRs with sulfur. Even so, after curing for 60 days, the Jₙᵣ values of BMRs with sulfur were still higher than those of the corresponding BMRs without sulfur, and the R values of BMRs with sulfur were still lower than those of the corresponding BMRs without sulfur, with one exception: the R of WP-BMR after 60 days curing at 0.1 kPa was slightly higher than that of WP-BMR without sulfur.

The CI based on Jₙᵣ and the CI based on R were assessed. From the Jₙᵣ-based CI, it can be seen that most sulfur-containing BMRs have a rapid change in Jₙᵣ in the first 14 days, and then reach a plateau. However, for sulfur-containing MS-BMR, the Jₙᵣ at 0.1 kPa decreased at high speed from 7 days, while the Jₙᵣ at 3.2 kPa maintained a relatively high decrease rate until 30 days curing. As for the R-based CI, R_{3.2 kPa}-based CI's for CO-BMR and WVO-BMR cannot be calculated since their uncured (W/S 0-d) recovery value was equal to zero. Sulfur-containing WVO-BMR reached a plateau in R-based CI with a high increase rate ahead of the others after 7 days, and the other four BMRs reached their plateaus after 30 days. Among five types of BMRs, CO-BMR shows a higher Jₙᵣ-based CI and WVO-BMR shows a higher R-based CI after 60 days of curing, indicating that these two rubberized bitumens containing vegetable-oil-based bio-modifiers have high reactivity with sulfur; this was further studied using chemical analysis.

### Chemical Analysis

FTIR was used to track the evolution of typical functional groups in BMRs. FTIR spectra were taken of five types of BMRs without (W/O S) and with sulfur before (W/S-0d) and after curing for 30 days (W/S-30d) and 60 days (W/S-60d) at room temperature. It was found that some absorption bands involving sulfur occurred in the BMRs containing sulfur; these are indicated by the red arrows in the spectra. The band located at 1275 to 1030 cm⁻¹ was assigned to S═C stretching, which can be related to thioketones. The band around 710 to 570 cm⁻¹ was assigned to S—C stretching in thiols, thioethers, and disulfides. These bands did not present in the BMRs without sulfur; they appeared after the addition of sulfur and kept growing with curing time up to 60 days, indicating the chemical structure of the BMRs was changed by the reaction between the sulfur and BMRs compounds.

For quantitative analysis of changes in chemical structure in BMRs due to sulfur incorporation and curing, bond indexes for the functional groups of S—H, C═O, S═C, S═O, S—C, and C═C were calculated using the equations below. The results show that curing can lead to a continuous chemical reaction between the bitumen compounds and sulfur that is reflected in the gradual increase of chemical bond indexes. These reactions are believed to be sulfur insertion into bitumen molecules and abstract hydrogen, thereby forming chemical bonds with bitumen compounds. Generally, with curing time extending up to 60 days, the bond indexes for all BMRs increased to varying degrees. The increase in bond indexes was clearer for CO-BMR and WVO-BMR after 60 days of curing, indicating that the molecules in these two vegetable-oil-based BMRs have high reactivity with sulfur. In addition, increases in the bond indexes of S═O, S═C, and S—C along with decreases in the bond indexes of C═O and C═C show that the alkenes and carbonyl in BMRs are sites of chemical reaction for sulfur and BMRs. By comparison, the BMRs containing plant-based bio-modifiers (CS, MS, and WP) were relatively inactive regarding the formation of chemical bonds. This difference indicates that the chemical reaction between the BMRs and sulfur has a strong dependence on the source of the bio-modifiers.

$${I}_{S - H} = \frac{Area of Peak between 2600 and 2550 {cm}^{- 1}}{Area of the Peak between 4000 and 400 {cm}^{- 1}}$$

$${I}_{S = C} = \frac{Area of Peak between 1275 and 1030 {cm}^{- 1}}{Area of the Peak between 4000 and 400 {cm}^{- 1}}$$

$${I}_{S = O} = \frac{Area of Peak between 1050 and 960 {cm}^{- 1}}{Area of the Peak between 4000 and 400 {cm}^{- 1}}$$

$${I}_{S - C} = \frac{Area of Peak between 710 and 570 {cm}^{- 1}}{Area of the Peak between 4000 and 400 {cm}^{- 1}}$$

$${I}_{C = O} = \frac{Area of Peak between 1800 and 1680 {cm}^{- 1}}{Area of the Peak between 4000 and 400 {cm}^{- 1}}$$

$${I}_{C = C} = \frac{Area of Peak between 1680 and 1620 {cm}^{- 1}}{Area of the Peak between 4000 and 400 {cm}^{- 1}}$$

### Comparison of the Effects of Sulfur on Different Types of BMRs

To compare the changes in properties of BMRs due to the addition of sulfur as well as the evolution of properties during the curing period, Table 4 summarizes the changes in properties of the five types of BMRs based on the indicators that were chosen to evaluate the effect of sulfur on the BMRs. For each metric, the BMR that has the highest changes in properties after 60 days of curing is given in the last column of Table 4. CO-BMR shows changes in properties related to pavement performance, while WVO-BMR shows substantial changes in properties related to chemical structure. Although WP-BMR has the highest properties changes for the Jₙᵣ at 0.1 kPa, the difference in the changing percent between the WP-BMR and other BMRs is small. The evident percent recovery increase of 257.4% for WVO-BMR indicates that the networking capacity of WVO-BMR was enhanced due to sulfur-BMR interaction with longer curing time, as sulfur atoms form cyclic octatomic molecules (S₈), and the cyclic ring could open to generate polysulfide chains. Meanwhile, sulfur radicals (S·) were generated at the end of the chain. These sulfur radicals are active and have a high potential to react with specific groups, such as the unsaturated carbon bond and carboxyl in CO-BMR and WVO-BMR, which inherently contain various unsaturated fatty acids. The sulfur radicals can abstract the oxygen in carboxyl to form S═C bonds, and the polysulfide chain with radicals at the end chemically binds the compounds of BMRs at the site of an unsaturated carbon bond by forming S—C bonds. In addition, the polysulfide chain with sulfur radicals could also abstract the hydrogen that is connected with carbon atoms, to induce the formation of an S—C bond and S—H group at the end of the polysulfide chain. Variation in curing trajectories were attributed to the presence of various bio-modifiers. As can be seen, CO-BMR and WVO-BMR had a much higher curing index compared to all other scenarios even though all cases were conditioned under the same exact curing protocol.

TABLE 4
Properties changes (in %) of five types of BMRs with sulfur
after 60 days curing, based on studied indicators.

| | | | | | | BMR with the | |
|---|---|---|---|---|---|---|---|
| | BMR | | | | | best CI in | |
| Metric | CO | CS | MS | WP | WVO | this metric | Criterion |
| G* @ 52° C., 10 | 201.6 | 136.0 | 126.9 | 134.9 | 120.8 | CO-BMR | Highest |
| rad/s | | | | | | | |
| δ @ 52° C., 10 rad/s | −10.0 | −6.3 | −7.7 | −7.3 | −5.3 | CO-BMR | Lowest |
| G*/sinδ @ 52° C. | 219.1 | 143.3 | 136.6 | 163.1 | 127.6 | CO-BMR | Highest |
| G*sinδ @ 52° C. | 184.1 | 129.0 | 117.6 | 137.0 | 114.5 | CO-BMR | Highest |
| J_{nr, 0.1 kPa} @ 52° C. | −76.7 | −67.0 | −64.4 | −78.8 | −65.4 | WP-BMR | Lowest |
| R_{0.1 kPa} @ 52° C. | 69.3 | 40.2 | 36.8 | 33.3 | 257.4 | WVO-BMR | Highest |
| I_{S═O} | 24.6 | 17.0 | 61.2 | 26.1 | 61.6 | WVO-BMR | Highest |
| I_{S—H} | 28.2 | 0.4 | 26.5 | 14.4 | 35.0 | WVO-BMR | Highest |
| I_{S—C} | 71.4 | 15.4 | 59.1 | 13.0 | 100.5 | WVO-BMR | Highest |
| I_{S═C} | 4.4 | 0.7 | 5.7 | 27.1 | 39.5 | WVO-BMR | Highest |
| I_{C═O} | −25.9 | −2.1 | 120.9 | −22.2 | −20.5 | CO-BMR* | Lowest |
| I_{C═C} | −10.7 | 14.2 | 42.3 | −0.5 | −10.8 | WVO-BMR* | Lowest |

It was found that the elasticity of all BMRs was reduced upon the introduction of sulfur; this was attributed to the sulfur-induced plasticizing effect on the bitumen. It was further observed that sulfur-added BMR showed evidence of curing with extended conditioning time. This was attributed to sulfur's re-crystallization as well as sulfur's reaction with the compounds in BMRs. As the curing progressed, the elastic properties of all BMRs increased. The progress of curing was reflected in an increase in the complex modulus and percent recovery, accompanied by a decrease in the phase angles and non-recoverable creep compliance.

The curing rate and extent of gain in properties varied among BMRs containing various types of bio-modifiers. Among the five types of BMRs, CO-BMR and WVO-BMR showed the highest curing rate. This was attributed to the high reactivity of the unsaturated compounds in vegetable oils (CO and WVO), which promotes reactions with sulfur. As evidenced in the FTIR spectra, carbon-sulfur bonds were formed gradually as curing progressed. This in turn enhanced the viscoelastic properties of BMRs, with those having bio-modifiers with a high content of unsaturated compounds showing more curing than others.

Thus, certain bio-modifiers were shown to increase sulfur-bitumen interactions and promote the bitumen's viscoelasticity while enhancing sustainability and resource conservation. The gain in viscoelasticity can be associated with both crystallization and sulfur-bitumen interactions.

### Example 3

Interactions between sulfur radical chains and unsaturated molecules of waste vegetable oil were shown to lead to chain reactions and subsequently a stable internal network in bitumen. Binders supplemented by waste vegetable oil and sulfur were shown to have a synergistic effect that leads to a highly effective hybrid binder.

Laboratory experiments showed the blend of bio-binder and sulfur thermally cured at 180° C. for 30 min demonstrates three times higher elasticity than the control binder. Conversely, the addition of sulfur without curing showed a negative effect on elasticity, measured as a significant reduction in the bitumen's complex modulus. The effect of ambient curing on regaining the lost modulus was limited; the sample did not fully regain its lost modulus even after 60 days of ambient curing. The significant effect of thermal curing was attributed to the reaction between sulfur and the bio-binder, as evidenced in FTIR spectra showing a significant reduction in alkene bonds.

Molecular models were used to further explore the underlying reaction mechanisms. Use of Fukui function values showed the highly vulnerable spots on the WVO to be the carbon atom on each side of the existing double bonds. The reaction starts with a radical sulfur chain interacting with one of the carbons on the side of a double bond and breaking the double bond. This first attack acts as a trigger, creating a vulnerable spot for a second attack that was found to be even more desirable, creating a stable bond. It was found that the feasible attack radii increased for the second attack, as well as the absorption energy and the bonding energy.

The effect of this polymerization mechanism at a larger scale for a matrix of bitumen was evaluated by MD analysis. The S (radical sulfur chains)-C (WVO) bonds that connect the hydrocarbons create a network within bitumen that enhances its cohesion, increasing its elasticity. This was evidenced by an experiment showing a three-fold increase in the complex modulus of the bitumen containing sulfur and waste vegetable oil after thermal curing. This mechanism explains the synergic effect found in experiment results.

Calculations show that potential covalent S—C bonds can provide many benefits for the overall bitumen structure. These bonds integrate various carbonaceous species to form larger and more formidable structures that deliver higher mechanical properties.

This example demonstrates the basis for chaining octasulfur to various hydrocarbon species present in bio-oils and bitumen and dissects many facets of sulfur-supplemented bitumen through methodical MD simulations and DFT calculations. The resulting combination, depending on its properties, can be used as a filler or as a supplement for reclaimed bitumen. Chemical stability of the product is another point of concern, which motivates testing against UV, heat, oxygen, and corrosive agents. In addition, it may be feasible to assess the adhesion between different aggregate base matrices and the resulting product, to investigate the feasibility of using it as a waterproof cover for the aggregates.

### Polymerizations

For polymerization with dicyclopentadiene (DCPD), sulfur was heated in a pot over an electrical hotplate, with the stirring provided by hand blending. Sulfur was fully melted at 160° C., and then DCPD was added. The mixture was continuously stirred and its temperature was kept at 160° C. for 2 hours. Polymerization was detected when the color of the mixture became increasingly darker until a dark brown near solid material was obtained. Before the mixture lost its heat, it was poured into molds and kept at an oven at 140° C. for 12 hours. It was then allowed to cool before being tested for its mechanical properties.

### Modified Bitumen

The asphalt used in this study was PG 64-22 (Table 5). The waste vegetable oil (WVO) was obtained from Mahoney Environmental Inc., Phoenix, AZ, a processing facility for waste vegetable oil. Sulfur with reagent grade was provided by Fisher Science Education. To prepare the specimens, 10 wt % sulfur was added to bitumen (that contained waste vegetable oil) and blended using a high-shear mixer at 3000 rpm. The sulfur-doped samples were cured at ambient temperature for 60 days before testing. In a second scenario, samples were melt-blended at 180° C. for 30 min, referred to as thermal curing.

TABLE 5
Basic properties of PG 64-22

| Properties | Values | Testing methods |
|---|---|---|
| Specific gravity @15.6° C. | 1.041 | ASTM D70 |
| Penetration @25° C. | 700.1 mm | ASTM D5 |
| Softening point | 46.0° C. | ASTM D36 |
| Ductility @ 15° C. | >100 cm | ASTM D113 |
| Cleveland open cup method flash point | 335° C. | ASTM D92 |
| Mass change after rolling thin-film oven test | −0.013% | ASTM D6 |
| Absolute viscosity @ 60° C. | 179 Pa · s | ASTM D2171 |
| Stiffness @−12° C., 60 s | 85.8 MPa | ASTM D6648 |

### Attenuated Total Reflectance Fourier-Transform Infrared Spectroscopy (ATR-FTIR)

For ATR analysis, built in ATR with diamond crystal was used in a Thermo Fisher Nicolet iS50 equipped with DTGS detector. Individual samples were placed on the ATR crystal to completely cover the 1 mm crystal surface. Uniform pressure was applied on all samples using the built-in pressure clamp. Scan parameters used were 128 scans and a resolution of 4 cm.⁻¹. Continuous heat monitoring was used with a temperature-controlled diamond ATR. Data was collected from ambient temperature to 180° C.; changes were also monitored as the sample cooled back to ambient temperature. Peak Area evaluation was carried out using Thermo Nicolet TQ analyst software. Analysis of spectra were carried out with OMNIC software. All peak areas were calculated with appropriate baseline corrections. Difference spectra was evaluated using subtract function in OMNIC software. To understand if the changes observed in the end point heated samples correspond to a continuous change in bond dynamics, samples were analyzed while being heated to 180° C. ATR-FTIR spectra was recorded as the sample temperature was ramped from 30° C. to 180° C., which allowed continuous analysis at the same spot in the sample to minimize any heterogeneity related variability.

### Gas Chromatography-Mass Spectroscopy

Waste vegetable oil was analyzed using a gas chromatography-mass spectrometer (GC-MS) for chemical and molecular composition. Each sample was dissolved in dichloromethane and filtered through a 0.2-μm PTFE filter prior to injection into the GC column. A DB-5 column (30 m×250 μm×0.25 μm) was used to separate molecules based on molecular weight. The carrier gas (helium) was maintained at 1 ml/min throughout the analysis. The samples were diluted 10-fold before 1 μl was injected into the column in split-less mode. The inlet temperature was maintained at 280° C.; the transfer-line temperature was 250° C., and the source temperature was 230° C. The chromatogram and the major peaks were processed and integrated using ChemStation and matched to the NIST17 database.

### Rheometry

Rheological analysis was performed using a dynamic shear rheometer (Anton Paar MCR 302). An oscillation test was performed at 52° C. and angular frequencies ranging from 0.1-100 rad/s using a parallel-plate setup. The sample was made into a disk 8 mm in diameter and 2 mm thick and placed in the parallel-plate setup to perform the test. The complex modulus (G*) was calculated from the equations below using shear strain and shear stress (Equation 2 and 3, respectively) data collected during the test.

$${G}^{*} = \frac{{τ}_{max}}{{γ}_{max}}$$

$$γ = {( \frac{θ r}{h} )}_{max}$$

$$τ = \frac{2 τ}{π {r}_{max}^{2}}$$

where γₘₐₓ is maximum strain, τₘₐₓ denotes maximum stress, T is maximum applied torque, r is radium of the sample, θ is the deflection (rotational) angle and h is the height of the sample.

### DFT Calculations and MD Simulations

Quantum-mechanical calculations in a dispersion-corrected density functional theory (DFT-D) framework were used to provide an atomistic description of the molecular system's performance. All optimizations were performed through the DMol3 module of the Accelrys Materials Studio program package (version 6.0). The generalized gradient approximation (GGA) and Perdew-Burke-Ernzerhof (PBE) functional were used to treat exchange-correlation interactions. PBE is the most universal GGA that could be applied to both molecules and solids. Errors of nonempirical functionals, such as PBE, usually have a “systematic” tendency. The systematic errors of PBE make it easier to estimate the target property. Moreover, these functionals provide a high accuracy for relative quantities such as bond length changes, frequency shifts, and energy differences.

In the MD simulation, a random algorithm was used to produce a sulfur composite modified by WVO. Herein, we considered 80% sulfur chains and 20% WVO for the composite, attached where the tendencies are maximum, i.e., where the carbon-sulfur bond is stable. The model was intended to preserve the periodic boundary conditions in three dimensions, thus presenting a suitable model for the sulfur composite under thermodynamic interactions with various molecules in the bitumen model. The dimensions for the periodic cell were set to 30 Å×A×30 Å. The COMPASS force field was used to model the interatomic interactions between a sulfur polymer and the bitumen m

The designed system reaches an equilibrium at its lowest energy level. Optimizing the structure of the nanocomposites and minimizing the energy level were achieved using the SMART method, which is a combination of the steepest descent, conjugate gradient, and Newton-Raphson methods. In order for the system to reach P=0.0001 GPa (air pressure) and T=400 K, a total analysis time of up to 500 ps with NPT ensemble was used to optimize the shape of the supercell and allow for the interactions to happen in 400 K. This was followed by 500 ps stabilization in 298 K; this process was designed to resemble the mixing and reacting process at high temperatures and stabilization at room temperature. Results were extracted under an NVT ensemble for 500 ps in 298 K to ensure constancy. A Nose thermostat and Berendsen barostat were set to control the temperature and pressure, respectively.

### Example 4

### Materials

The reference (control) sample was bio-modified rubberized (BMR) bitumen. This includes five different BMR made from Castor oil (CO-BMR), Corn Stover (CS-BMR), Miscanthus (MS-BMR), Wood Pellet (WP-BMR), and Waste Vegetable Oil (WVO-BMR); the basic properties of bio-modifiers are given in Table 6. The preparation of BMRs was done by following methods known in the art. To prepare BMRs, crumb rubber (15% wt.) and bio-modifiers (15% wt.) were added into PG 64-22 (70% wt.) (Table 7) and mixed at 180±5° C. for min with a shearing speed of 3000 rpm. The crumb rubber had a particle size smaller than mm and was made from waste tire rubber. Bio-modifiers were obtained from biomass. Each of the abovementioned BMRs were modified with 10% sulfur by weight of the corresponding BMR. Sulfur was obtained from Fisher Science Education with a reagent grade. Mixing of sulfur and BMRs was done at a temperature of 155±5° C. for 30 minutes using a mixer at 1000 rpm.

TABLE 6
Basic properties of bio-modifiers

| Properties | CO | CS | MS | WP | WVO |
|---|---|---|---|---|---|
| Density (g/cm³) | 0.881 | 1.250 | 1.050 | 1.230 | 0.898 |
| C (%) | 77.80 | 61.6 | 65.77 | 61.05 | 77.30 |
| H (%) | 12.66 | 7.28 | 7.31 | 6.93 | 12.08 |
| O (%) | 9.46 | 30.16 | 26.25 | 31.81 | 10.50 |
| N (%) | 0.08 | 0.96 | 0.67 | 0.21 | 0.12 |
| Saturates (%) | 20.95 | 6.8 | 6.22 | 3.46 | 0.00 |
| Aromatics (%) | 0.00 | 3.73 | 8.56 | 2.93 | 87.19 |
| Resins (%) | 78.17 | 67.49 | 60.47 | 76.21 | 12.80 |
| Asphaltenes (%) | 0.87 | 21.96 | 24.47 | 17.38 | 0.00 |

TABLE 7
General properties of PG 64-22

| Properties | Values |
|---|---|
| Specific gravity @15.6° C. | 1.041 |
| Cleveland open cup method flash | 335° C. |
| point | |
| Mass change after RTFO | −1.3% |
| Absolute viscosity @ 60° C. | 179 Pa · s |
| Stiffness @−12° C., 60 s | 85.8 MPa |

### Methods

The prepared BMR specimens containing sulfur were placed at room temperature for five curing times: 0, 7, 14, 30, and 60 days.

### Tests of Rheological Properties

An Anton Paar MCR 302 dynamic shear rheometer was used to test the rheological properties of the BMRs with and without sulfur dopant. The frequency sweep at 52° C. with angular frequencies ranging from 0.1 rad/s to 100 rad/s using a parallel plate (8-mm diameter) with 2-mm gap was used to measure the complex modulus (G*) and phase angle (6) of the BMRs. The multiple stress creep and recovery test (MSCR) was conducted at 52° C. using 25-mm plate to obtain the percent recovery (R) and non-recoverable creep compliance (J) of the BMRs. Ten cycles of 1-second creep and 9-seconds recovery were applied to the samples under two stress levels (0.1 kPa and 3.2 kPa). The frequency sweep and MSCR testing procedures followed the standard test methods of ASTM D7175 and AASHTO T350, respectively

### Attenuated Total Reflectance-Fourier Transform Infrared Spectroscopy (ATR-FTIR)

A Bruker IFS 66V/S Vacuum FTIR with diamond ATR was used to detect changes in the functional groups of BMRs with/without sulfur. The diamond crystal surface was cleaned with acetone before testing, and the background spectrum was collected first and subtracted from the spectra of the tested sample. The wavenumber ranged from 4800 to 400 cm⁻¹ with a scan frequency of 32 times/min at a resolution of 4 cm⁻¹ in a vacuum environment at room temperature. A flowchart below illustrates the experimental process and variables.

### Complex Modulus and Phase Angles

The dynamic frequency sweep test for all BMRs without and with sulfur was conducted at 52° C. It was found that the addition of sulfur (W/S-0d) reduced the G* of all BMRs significantly comparing to the control BMRs (W/O S). As G* is a key indicator used to represent the stiffness of bitumen at intermediate temperatures, the decreased G* indicated that sulfur incorporation softened the BMRs; this softening is attributed to that sulfur may act as a weak-phase in bitumen matrix due to the plasticizing effect of sulfur on the bitumen, such sulfur-induced plasticity should be responsible for the reduced G*. The sulfur in bitumen exists in three forms: dissolved sulfur, chemically bonded sulfur, and crystalline sulfur. The proportion of chemically bonded sulfur highly depends on bitumen compositions with phenolic compounds shows a high affinity for the reaction; however, overall the sulfur-reacted compounds are low because of the reaction time and temperature during the blending is relatively. The sulfur does not crystallize immediately upon cooling, so the proportion of crystallized sulfur is low as well. Accordingly, most of the sulfur phase remains in the amorphous and dissolved form, this in turn softens the bitumen. As time elapses, the sulfur continues to react with the bitumen components giving rise to internal network of organic molecules while excess sulfur crystallizes into micrometer-sized structures. The latter can lead to the so-called curing phenomenon, which increases bitumen stiffness. The G* of BMRs increased gradually as the curing time increased from 0 days to 60 days, and the G* of rubberized bitumens cured for 60 days containing the bio-modifiers CO, CS, and MS were close to or even above the original G* of the BMRs. CO-BMR and WVO-BMR had the highest G* increase during the first 7 days of curing; after that, the increase became slower. To ensure that the observed property change is due to sulfur dopant, the reference materials (BMRs) were exposed to the same exact curing condition and no changes were observed. The latter was examined by comparing each BMRs complex modulus before and after curing condition. The results showed that there were no changes in the properties of BMRs conditioned to the same exact curing protocol as sulfur-doped BMRs. This in turn confirms that the observed property changes in sulfur-doped BMRs are indeed due to the curing phenomenon. The recrystallization of the dissolved and dispersed sulfur in the bitumen matrix and the continuous sulfur-BMR interaction during the curing time can explain the G* increase during the curing. The introduced sulfur can partially congeal into crystalline sulfur particles and give additional strength to the bitumen. The sulfur continues to react with the bitumen compounds and form sulfur-containing networks in the bitumen phase, thus enhancing the elasticity of the bitumen. As a result, the G* of the BMRs increased with increased curing time.

The phase angle (δ) of WVO-BMR increased by roughly 8 degrees after adding sulfur, followed by CO-BMR (˜10 degrees), MS-BMR (16 degrees), and CS-BMR (˜18 degrees); WP-BMR showed the highest increase by roughly 22 degrees. The increase in δ indicates increased viscous response for BMRs, resulting in rutting risk at high temperature but desirable cracking resistance at low temperature. During the curing process, the δ of all BMRs continued to decrease. CO-BMR had a significant decrease in δ during the first 7 days and caught up to the δ of the bitumen without sulfur after 60 days of curing. This phenomenon was also found in WVO-BMR. However, the δ of CS-BMR, MS-BMR, and WP-BMR basically remained unchanged after 7 days of curing, and there were still great gaps in δ between the samples cured for 60 days and the original samples. Overall, the viscoelastic indicators of G* and δ show the softening of BMRs due to the incorporation of sulfur and hardening of BMRs after curing.

### Rutting Resistance Indicator (G*/Sin δ)

The Superpave rutting parameter G*/sin δ, known as the rutting factor, was calculated to evaluate the effect of sulfur on the high-temperature performance of BMRs. The original BMRs were softened by the dissolved and dispersed sulfur, as shown by the decrease in G*/sin δ of W/S-0d. However, G*/sin δ grew gradually during the curing, showing improved rutting resistance. After 60 days of curing, the G*/sin δ values of all BMRs containing sulfur, except WP-BMR, were approximately equal to the G*/sin δ values of the original BMRs without sulfur; this can be attributed to the aforementioned sulfur recrystallization and reaction with bitumen compounds.

To further investigate the evolution of the properties of rubberized bitumen containing different types of bio-modifiers, the Curing Index (CI) of each of the five types of BMRs with sulfur was calculated according to the equation below, based on the change in their properties during each curing period. The CI is the percent change of each property before and after curing. In other words, CI is used as an indirect measure of sulfur-bitumen reaction. The fact that each bio-modified bitumen showed a unique CI value even though they were all exposed to the same conditioning protocol, shows curing is highly affected by bitumen's composition. This, in turn, highlights the source dependency of the effect of sulfur on bio-modified rubberized bitumen.

$$CI = \vert \frac{cured value - uncured value}{uncured value} \vert \times 100 \%$$

For CO-BMR and WVO-BMR, the CI increased rapidly in the first 14 days. For CS-BMR and WP-BMR, the CI did not change much in the first 7 days, then it increased rapidly in the section to 14 days. The CI of MS-BMR also did not show much increase in the first 7 days, then grew at a higher rate from 7 to 30 days. One similarity is that the growth of all BMRs slowed at 30 days. After 60 days of curing, CO-BMR showed the highest change in rutting factor with the highest CI, followed by WP-BMR, CS-BMR, MS-BMR, and WVO-BMR.

### Fatigue Performance Indicator (G*Sin δ)

The Superpave fatigue factor G* sin δ was also used to evaluate the fatigue performance of the BMRs without and with sulfur. With the addition of sulfur to the BMRs, their G* sin δ values have great reductions and show enhanced fatigue resistance of the bitumen. All BMRs with sulfur showed a similar trend during the curing period: a noticeable increase in G*sin δ values, indicating decreased fatigue resistance. Among the five types of BMRs, the G* sin δ values of CS-BMR and MS-BMR after 60 days of curing exceed those of their corresponding original BMRs without sulfur. The evolution of G*sin δ-based CI had the same trend as for G*/sin δ-based CI; after 60 days, CO-BMR shows the highest CI (and was highest during the curing), followed by WP-BMR, CS-BMR, MS-BMR, and WVO-BMR.

### Multiple Stress Creep and Recovery Test (MSCR)

Creep and recovery tests were conducted to evaluate the effects of sulfur on the elastic response and resistance to permanent deformation of the BMRs at high temperature. The addition of sulfur had a great impact on the creep and recovery response of BMRs. The WP-BMR had a huge surge in Jₙᵣ by 1680.0% (average increase percent at 0.1 kPa and 3.2 kPa, the same below), followed by CS-BMR (1105.1%), MS-BMR (931.0%), and CO-BMR (442.6%), while WVO-BMR had a relatively small increase of 398.9%. The R suffered a significant decrease with the addition of sulfur. Decreases of 46.3%, 53.0%, 42.4%, 16.8%, and 77.6% were observed at 0.1 kPa for R of CO-BMR, CS-BMR, MS-BMR, WP-BMR, and WVO-BMR, respectively. At 3.2 kPa, the R of CO-BMR and WVO-BMR decreased to zero, and those samples totally lost their elasticity. However, as demonstrated in the section on complex modulus and phase angles, sulfur-containing BMRs could recover part of their elastic properties during the curing, due to sulfur recrystallization and sulfur-BMR chemical reactions. Thus, a continuous decrease in Jₙᵣ and increase in R were observed for the cured BMRs with sulfur. Even so, after curing for 60 days, the Jₙᵣ values of BMRs with sulfur were still higher than those of the corresponding BMRs without sulfur, and the R values of BMRs with sulfur were still lower than those of the corresponding BMRs without sulfur, with one exception: the R of WP-BMR after 60 days curing at 0.1 kPa was slightly higher than that of WP-BMR without sulfur.

The Jₙᵣ-based CI shows that most sulfur-containing BMRs have a rapid change in Air in the first 14 days, and then reach a plateau. However, for sulfur-containing MS-BMR, the Jₙᵣ at 0.1 kPa decreased at high speed from 7 days, while the Jₙᵣ at 3.2 kPa maintained a relatively high decrease rate until 30 days curing. As for the R-based CI, it should be noted that R_{3.2 kPa}-based CI's for CO-BMR and WVO-BMR cannot be calculated since their uncured (W/S 0-d) recovery value was equal to zero. From the available data, sulfur-containing WVO-BMR reached a plateau in R-based CI with a high increase rate ahead of the others after 7 days, and the other four BMRs reached their plateaus after 30 days. Among five types of BMRs, CO-BMR shows a higher Jₙᵣ-based CI and WVO-BMR shows a higher R-based CI after 60 days of curing, indicating that these two rubberized bitumens containing vegetable-oil-based bio-modifiers have high reactivity with sulfur; this was further studied using chemical analysis.

### Chemical Analysis

FTIR was used to track the evolution of typical functional groups in BMRs. Some absorption bands involving sulfur occurred in the BMRs containing sulfur. A band located at 1275 to 1030 cm⁻¹ was assigned to S═C stretching, which can be related to thioketones. The band around 710 to 570 cm⁻¹ was assigned to S—C stretching in thiols, thioethers, and disulfides. These bands did not present in the BMRs without sulfur; they appeared after the addition of sulfur and kept growing with curing time up to 60 days, indicating the chemical structure of the BMRs was changed by the reaction between the sulfur and BMRs compounds.

For quantitative analysis of changes in chemical structure in BMRs due to sulfur incorporation and curing, bond indexes for the functional groups of S—H, C═O, S═C, S═O, S—C, and C═C were calculated using the following equations. Results show that curing can lead to a continuous chemical reaction between the bitumen compounds and sulfur that is reflected in the gradual increase of chemical bond indexes. These reactions are believed to be sulfur insertion into bitumen molecules and abstract hydrogen, thereby forming chemical bonds with bitumen compounds. Generally, with curing time extending up to 60 days, the bond indexes for all BMRs increased to varying degrees. The increase in bond indexes was clearer for CO-BMR and WVO-BMR after 60 days of curing, indicating that the molecules in these two vegetable-oil-based BMRs have high reactivity with sulfur. In addition, increases in the bond indexes of S═O, S═C, and S—C along with decreases in the bond indexes of C═O and C═C show that the alkenes and carbonyl in BMRs are sites of chemical reaction for sulfur and BMRs. By comparison, the BMRs containing plant-based bio-modifiers (CS, MS, and WP) were relatively inactive regarding the formation of chemical bonds. This difference indicates that the chemical reaction between the BMRs and sulfur has a strong dependence on the source of the bio-modifiers.

$${I}_{S - H} = \frac{Area of Peak between 2600 and 2550 {cm}^{- 1}}{Area of the Peak between 4000 and 400 {cm}^{- 1}}$$

$${I}_{S = C} = \frac{Area of Peak between 1275 and 1030 {cm}^{- 1}}{Area of the Peak between 4000 and 400 {cm}^{- 1}}$$

$${I}_{S = O} = \frac{Area of Peak between 1050 and 960 {cm}^{- 1}}{Area of the Peak between 4000 and 400 {cm}^{- 1}}$$

$${I}_{S - C} = \frac{Area of Peak between 710 and 570 {cm}^{- 1}}{Area of the Peak between 4000 and 400 {cm}^{- 1}}$$

$${I}_{C = O} = \frac{Area of Peak between 1800 and 1680 {cm}^{- 1}}{Area of the Peak between 4000 and 400 {cm}^{- 1}}$$

$${I}_{C = C} = \frac{Area of Peak between 1680 and 1620 {cm}^{- 1}}{Area of the Peak between 4000 and 400 {cm}^{- 1}}$$

### Comparison of the Effects of Sulfur on Different Types of BMRs

To compare the changes in properties of BMRs due to the addition of sulfur as well as the evolution of properties during the curing period, Table 8 summarizes the changes in properties of the five types of BMRs based on the indicators that were chosen to evaluate the effect of sulfur on the BMRs. For each metric, the BMR that has the highest changes in properties after 60 days of curing is given in the last column of Table 8. CO-BMR shows significant changes in properties related to pavement performance, while WVO-BMR shows substantial changes in properties related to chemical structure. Although WP-BMR has the highest properties changes for the Jₙᵣ at 0.1 kPa, the difference in the changing percent between the WP-BMR and other BMRs is very small. The evident percent recovery increase of 257.4% for WVO-BMR indicates that the networking capacity of WVO-BMR was enhanced due to sulfur-BMR interaction with longer curing time, as sulfur atoms form cyclic octatomic molecules (S₈), and the cyclic ring could open to generate polysulfide chains. Meanwhile, sulfur radicals (S·) were generated at the end of the chain. These sulfur radicals are active and have a high potential to react with specific groups, such as the unsaturated carbon bond and carboxyl in CO-BMR and WVO-BMR, which inherently contain various unsaturated fatty acids. The sulfur radicals can abstract the oxygen in carboxyl to form S═C bonds, and the polysulfide chain with radicals at the end chemically binds the compounds of BMRs at the site of an unsaturated carbon bond by forming S—C bonds. In addition, the polysulfide chain with sulfur radicals could also abstract the hydrogen that is connected with carbon atoms, to induce the formation of an S—C bond and S—H group at the end of the polysulfide chain. Variation in curing trajectories when conditioned to the same exact curing protocol were seen. The variation was attributed at least in part to the presence of various bio-modifiers; the composition of various bio-modifiers has been reported elsewhere. CO-BMR and WVO-BMR had a much higher curing index compared to all other scenarios even though all cases were conditioned under the same exact curing protocol.

TABLE 8
Properties changes (in %) of five types of BMRs with sulfur
after 60 days curing, based on studied indicators

| | | | | | | BMR with the | |
|---|---|---|---|---|---|---|---|
| | BMR | | | | | best CI in | |
| Metric | CO | CS | MS | WP | WVO | this metric | Criterion |
| G* @ 52° C., 10 | 201.6 | 136.0 | 126.9 | 134.9 | 120.8 | CO-BMR | Highest |
| rad/s | | | | | | | |
| δ @ 52° C., 10 rad/s | −10.0 | −6.3 | −7.7 | −7.3 | −5.3 | CO-BMR | Lowest |
| G*/sinδ @ 52° C. | 219.1 | 143.3 | 136.6 | 163.1 | 127.6 | CO-BMR | Highest |
| G*sinδ @ 52° C. | 184.1 | 129.0 | 117.6 | 137.0 | 114.5 | CO-BMR | Highest |
| J_{nr, 0.1 kPa} @ 52° C. | −76.7 | −67.0 | −64.4 | −78.8 | −65.4 | WP-BMR | Lowest |
| R_{0.1 kPa} @ 52° C. | 69.3 | 40.2 | 36.8 | 33.3 | 257.4 | WVO-BMR | Highest |
| I_{S═O} | 24.6 | 17.0 | 61.2 | 26.1 | 61.6 | WVO-BMR | Highest |
| I_{S—H} | 28.2 | 0.4 | 26.5 | 14.4 | 35.0 | WVO-BMR | Highest |
| I_{S—C} | 71.4 | 15.4 | 59.1 | 13.0 | 100.5 | WVO-BMR | Highest |
| I_{S═C} | 4.4 | 0.7 | 5.7 | 27.1 | 39.5 | WVO-BMR | Highest |
| I_{C═O} | −25.9 | −2.1 | 120.9 | −22.2 | −20.5 | CO-BMR* | Lowest |
| I_{C═C} | −10.7 | 14.2 | 42.3 | −0.5 | −10.8 | WVO-BMR* | Lowest |

The extent to which the evolution of rheological and chemical properties of sulfur-added bio-modified rubberized bitumen (BMR) depended on the source of the bio-modifier was identified. The elasticity of all BMRs was reduced significantly upon the introduction of sulfur; which was attributed at least in part to the sulfur-induced plasticizing effect on the bitumen. sulfur-added BMR showed evidence of curing with extended conditioning time. This was attributed at least in part to sulfur's re-crystallization as well as sulfur's reaction with the compounds in BMRs. As the curing progressed, the elastic properties of all BMRs increased. The progress of curing was reflected in an increase in the complex modulus and percent recovery, accompanied by a decrease in the phase angles and non-recoverable creep compliance.

The curing rate and extent of gain in properties varied among BMRs containing various types of bio-modifiers. Among the five types of BMRs, CO-BMR and WVO-BMR showed the highest curing rate. This was attributed to the high reactivity of the unsaturated compounds in vegetable oils (CO and WVO), which promotes reactions with sulfur. As evidenced in FTIR spectra, carbon-sulfur bonds were formed gradually as curing progressed. This in turn enhanced the viscoelastic properties of BMRs, with those having bio-modifiers with a high content of unsaturated compounds showing more curing than others.

Thus, an increase sulfur-bitumen interactions promote the bitumen's viscoelasticity while enhancing sustainability and resource conservation. The gain in viscoelasticity can be associated with both crystallization and sulfur-bitumen interactions.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A method of forming modified bitumen, the method comprising:
contacting oil with bitumen to yield a bitumen matrix comprising the oil;
combining sulfur with the bitumen matrix; and
reacting the sulfur with the oil to yield the modified bitumen.

2. The method of claim 1, wherein the sulfur comprises elemental sulfur.

3. The method of claim 1, wherein reacting the sulfur with the oil comprises crosslinking the oil with the sulfur, and crosslinking the oil with sulfur comprises reacting the sulfur with an unsaturated hydrocarbon in the oil.

4. (canceled)

5. The method of claim 3, wherein reacting the sulfur with the unsaturated hydrocarbon comprises reacting the sulfur with carbon-carbon double bonds in the unsaturated hydrocarbons.

6. The method of claim 5, wherein reacting the sulfur with the carbon-carbon double bonds in the unsaturated hydrocarbons comprises a chain reaction of sulfur radicals with the unsaturated hydrocarbons.

7. The method of claim 6, wherein reacting the sulfur radicals with the carbon-carbon double bonds comprises forming a first carbon-sulfur bond with a first carbon in a carbon-carbon double bond to yield a yield a first radical sulfur chain bonded to the first carbon in the carbon-carbon double bond.

8. The method of claim 7, wherein reacting the sulfur radicals with the carbon-carbon double bonds further comprises forming a second carbon-sulfur bond with a second carbon in the carbon-carbon double bond to yield a yield a second radical sulfur chain bonded to the second carbon in the carbon-carbon double bond.

9. The method of claim 1, further comprising melt-blending the sulfur into the bitumen matrix.

10. The method of claim 9, further comprising thermally curing modified bitumen.

11. The method of claim 10, wherein thermally curing the modified bitumen comprises heating the modified bitumen to a temperature above about 150° C.

12. (canceled)

13. (canceled)

14. The method of claim 1, wherein the oil comprises waste vegetable oil.

15. (canceled)

16. The method of claim 1, wherein the oil comprises bio-oil, the bio-oil comprises phenolic compounds.

17. The method of claim 16, wherein the phenolic compounds react with sulfur radicals to form carbon-sulfur bonds.

18. The method of claim 1, wherein the sulfur comprises thiophenic sulfur.

19. (canceled)

20. (canceled)

21. A modified bitumen formed by the method of claim 1.

22. A modified bitumen composition comprising:
bitumen;
a sulfur component; and
an oil component,
wherein the sulfur component is bonded covalently to the oil component, and the oil component is bonded covalently to the bitumen.

23. The modified bitumen composition of claim 22, wherein the bitumen is in the form of a bitumen matrix, and further comprising a polymer within the bitumen matrix, wherein the polymer comprises a crosslinked oil-sulfur network and the sulfur in the oil-sulfur network comprises sulfur chains.

24. (canceled)

25. (canceled)

26. (canceled)

27. The modified bitumen composition of claim 22, wherein the oil comprises waste vegetable oil.

28. The modified bitumen composition of claim 27, wherein the vegetable oil comprises cis-vaccenic acid, trans-2-undecen-1-ol, 10(E),12(Z)-conjugated linoleic acid, 2-linoleoyl glycerol, or a combination thereof.

29. The modified bitumen composition of claim 22, wherein the oil comprises bio-oil, the bio-oil comprises phenolic compounds.

30. The modified bitumen composition of claim 29, wherein the phenolic compounds are bonded covalently with the sulfur component.

31. The modified bitumen composition of claim 22, wherein the sulfur component comprises thiophenic sulfur.

32. (canceled)

33. The modified bitumen composition of claim 22, wherein the bitumen composition comprises 1 wt % to 15 wt % or 5 wt % to 10 wt % sulfur.

34. (canceled)

35. The modified bitumen composition of claim 22, wherein the bitumen further comprises crumb rubber.

36. The modified bitumen composition of claim 35, wherein the bitumen comprises 1 wt % to 15 wt % or 5 wt % to 10 wt % of the crumb rubber.

37. An asphalt comprising the modified bitumen composition of claim 22.
